(19) United States
(12) Patent Application Publication
(10) Pub. No.: US 2006/0170403 A1
(43) Pub. Date: Aug. 3, 2006

(54) Voltage regulator with reduced power consumption in standby operating mode

(76) Inventor: Joon-Hyuk Im, Seoul (KR)

Correspondence Address: LAW OFFICE OF MONICA H CHOI, P O BOX 3424, DUBLIN, OH, 430160204, US

(21) Appl. No.: 11/327,233

(22) Filed: Jan. 6, 2006

(30) Foreign Application Priority Data
Jan. 28, 2005 (KR) 2005-08151

(51) Int. Cl. G05F 1/56; G05F 1/618

(52) U.S. Cl. 323/280

(57) ABSTRACT

A voltage regulator includes separate circuit paths used for generating regulated voltages in the normal operating mode and the standby operating mode. Circuit components that consume relatively high power in the normal operating mode are turned off during the standby operating mode. Thus, power consumption is minimized even while a regulated voltage is generated during the standby operating mode.

### BACKGROUND OF THE INVENTION

This application claims priority to Korean Patent Application No. 2005-08151 filed on Jan. 28, 2005, in the Korean Intellectual Property Office, the disclosure of which is incorporated herein in its entirety by reference.

1. Field of the Invention

The present invention relates generally to voltage regulators, and more particularly to a voltage regulator that generates a regulated voltage with reduced power consumption during a standby operating mode.

2. Description of the Related Art

A voltage regulator generates a regulated voltage with a stable target level. An example voltage regulator 10 in a semiconductor device is disclosed in Korean Patent No. 10-0362700 as shown in FIG. 1. As illustrated in FIG. 1, the voltage regulator 10 includes a comparator COMP, a PMOS transistor MP1 forming a driver, and resistors R1 and R2 forming a voltage divider.

The comparator COMP determines whether a fed-back voltage Vdiv from the voltage divider is lower than a reference voltage Vref. The PMOS transistor MP1 operates in accordance with such a determination by the comparator COMP. For instance, if an output voltage VPPi adjusted by the voltage regulator 10 is lower than a target voltage (i.e., Vref>Vdiv), a current flows through the PMOS transistor MP1 until the voltage VPPi reaches the target voltage. To the contrary, if the output voltage VPPi is higher than the target voltage (i.e., Vref<Vdiv), the current flow through the PMOS transistor MP1 is interrupted until the output voltage VPPi is decreased to the target voltage.

A system may require a regulated voltage even during a standby operating mode. However, the voltage regulator 10 may not be efficient enough for purposes of power conservation in the standby operating mode.

### SUMMARY OF THE INVENTION

Accordingly, a voltage regulator of the present invention provides regulated voltages in both a normal operating mode and a standby operating mode with power conservation in the standby operating mode.

A voltage regulator in a general embodiment of the present invention includes a feed-back path and a divider path. The feed-back path generates a first regulated voltage using feed-back during the normal operating mode. On the other hand, the divider path generates a second regulated voltage using voltage division during the standby operating mode.

In one embodiment of the present invention, the feed-back path is disabled during the standby operating mode to minimize power consumption.

In another embodiment of the present invention, the divider path includes a voltage divider having a plurality of resistors coupled between a ground node and a terminal for an input voltage during the standby operating mode.

In a further embodiment of the present invention, the feed-back path includes a voltage divider, a reference voltage generator, an active device, and a comparator. The voltage divider has a first plurality of resistors for generating the first regulated voltage and a fed-back voltage. The reference voltage generator generates a reference voltage. The active device is coupled to the voltage divider, and is controlled by the comparator that compares the fed-back voltage with the reference voltage. The active device determines a current level flowing through the first plurality of resistors that generates the first regulated voltage.

In an example embodiment of the present invention, the active device is a PMOS transistor coupled between an input voltage and the first plurality of resistors.

In a further aspect of the present invention, the reference voltage generator, the active device, and the comparator are turned on during the normal operating mode and are turned off during the standby operating mode.

In another aspect of the present invention, the divider path includes at least one additional resistor coupled in series with the first plurality of resistors between a ground node and a terminal for an input voltage during the standby operating mode.

In an example embodiment of the present invention, a switching device is coupled between the at least one additional resistor and the first plurality of resistors. The switching device is turned on during the standby operating mode and is turned off during the normal operating mode.

In one embodiment of the present invention, the first regulated voltage and the second regulated voltage are generated at a same output node. In another example embodiment of the present invention, the first regulated voltage and the second regulated voltage are substantially equal.

In this manner, separate circuit paths are used for generating regulated voltages in the normal operating mode and the standby operating mode. Circuit components that consume relatively high power in the normal operating mode are turned off during the standby operating mode. Thus, power consumption is minimized while a regulated voltage is generated during the standby operating mode.

### BRIEF DESCRIPTION OF THE DRAWINGS

The above and other features and advantages of the present invention will become more apparent when described in detailed exemplary embodiments thereof with reference to the attached drawings in which:

FIG. 1 is a circuit diagram of a conventional voltage regulator; and

FIG. 2 is a circuit diagram of a voltage regulator with minimized power consumption during the standby operating mode, according to an example embodiment of the present invention.

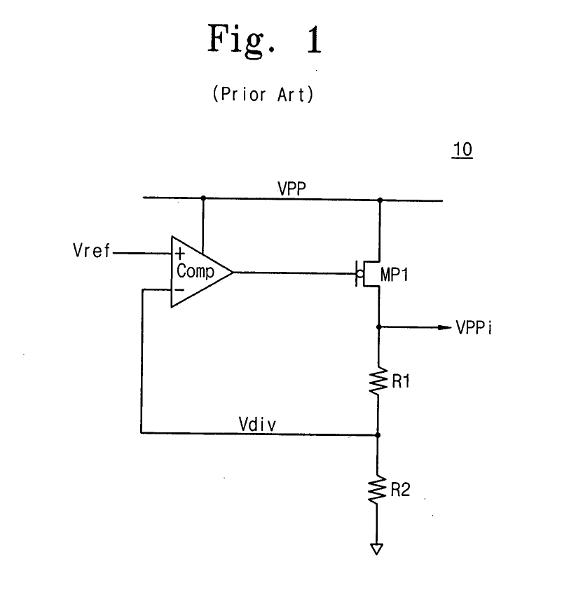

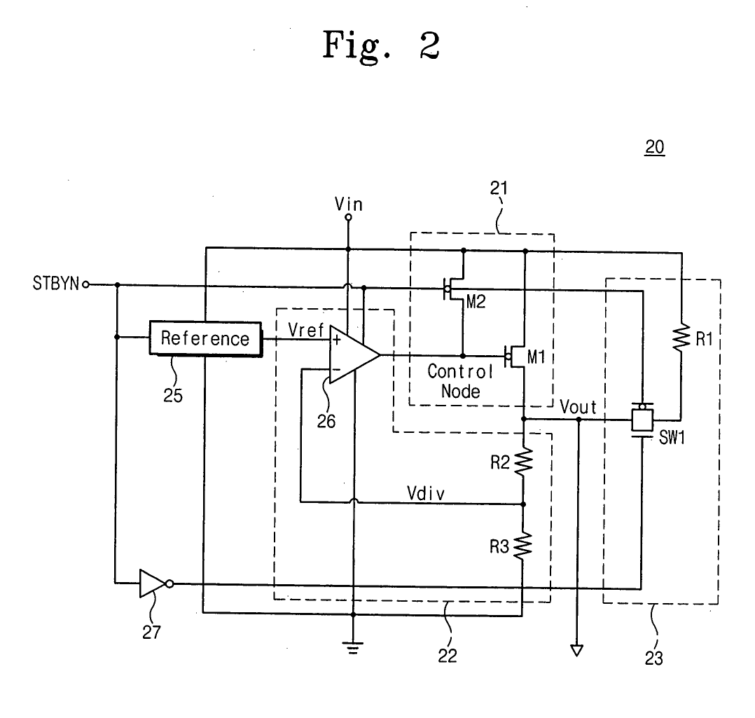

The figures referred to herein are drawn for clarity of illustration and are not necessarily drawn to scale. Elements having the same reference number in FIGS. 1 and 2 refer to elements having similar structure and/or function.

### DETAILED DESCRIPTION OF THE INVENTION

Preferred embodiments of the present invention are described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the invention to those skilled in the art. Like numerals refer to like elements throughout the specification.

FIG. 2 shows a circuit diagram of a voltage regulator 20 in accordance with one embodiment of the present invention. The voltage regulator 20 receives an input voltage Vin and a standby signal STBYN to generate regulated target voltages at an output node labeled Vout in FIG. 2. The standby signal STBYN indicates a type of operating mode including a normal operating mode or a standby operating mode. The standby signal STBYN is supplied from an external controller (not shown) for indicating the type of operating mode, becoming a logic high level in the normal operating mode and a logic low level in the standby operating mode.

The voltage regulator 20 is comprised of a reference voltage generator 25, a driver 21, a control signal generator 22, a second voltage divider 23, and an inverter 27. The reference voltage generator 25 is a voltage source independent from the input voltage Vin. The reference voltage generator 25 generates the reference voltage Vref supplied to the comparator 26 during the normal operating mode when the standby signal STBYN is at the logic high level.

The driver 21 includes a first PMOS (P-channel metal oxide semiconductor) transistor M1 and a second PMOS transistor M2. The first PMOS transistor M1 is coupled between the terminal having the input voltage Vin applied thereon and the output node Vout. The second PMOS transistor M2 is coupled between the terminal having the input voltage Vin applied thereon and the gate of the first PMOS transistor M1. The gate of the second PMOS transistor M2 is coupled to the terminal having the STBYN signal applied thereon.

The sources of the PMOS transistors M1 and M2 are coupled to the terminal having the input voltage Vin applied thereon. The output of a comparator 26 is applied at a CONTROL NODE within the driver 21. The gate of the first PMOS transistor M1 and the drain of second PMOS transistor M2 are coupled to such a CONTROL NODE. The drain of the first PMOS transistor M1 is coupled to the output node Vout.

The comparator 26 is within the control signal generator 22 which further includes resistors R2 and R3 forming a first voltage divider. The resistors R2 and R3 are coupled in series between the output node Vout and a ground node. The comparator 26 drives the first PMOS transistor M1 from a result of comparing a fed-back voltage Vdiv and the reference voltage Vref from the reference voltage generator 25. The fed-back voltage Vdiv is generated between the resistors R2 and R3 of the first voltage divider.

Operation of the comparator 26 is controlled by the standby signal STBYN. For example, the comparator 26 becomes operable when the standby signal is a logic high level during the normal operating mode. On the other hand, the comparator 26 becomes disabled when the standby signal is a logic low level during the standby operating mode.

The second voltage divider 23 includes a switch SW1 and a resistor R1. The switch SW1 is implemented with two complementary pass transistors in one embodiment of the present invention. The sources of the complementary pass transistors SW1 are coupled together, and the drains of the complementary pass transistors SW1 are coupled together. Referring to FIG. 2, the two complementary pass transistors are coupled between the output node Vout and the resistor R1.

The gate of a P-channel transistor of the switch SW1 has the standby signal STBYN applied thereon. The gate of an N-channel transistor of the switch SW1 has the inverse of the standby signal STBYN applied thereon via an inverter 27. The resistor R1 is coupled between the switch SW1 and the terminal having the input voltage Vin applied thereon.

When the standby signal STBYN is a logic low level during the standby operating mode, the switch SW1 is turned on to connect the resistor R1 with the output node Vout. Otherwise, the switch SW1 is turned off during the normal operating mode to disconnect the resistor R1 from the output node Vout when the standby signal STBYN is a logic high level.

The voltage regulator 20 operates as follows when the standby signal STBYN is a logic high level during the normal operating mode. During such a normal operating mode, the reference voltage generator 25 and the comparator 26 are enabled by the logic high level of the standby signal STBYN. Thus in the normal operating mode, the reference voltage generator 25 generates the reference voltage Vref.

Also during the normal operating mode, the second PMOS transistor M2 is turned off while the first PMOS transistor M1 is turned on to have a current flowing there-through. Additionally during the normal operating mode, the switch SW1 is turned off to disconnect the resistor R1 from the output node Vout.

In this manner during the normal operating mode, a first regulated voltage is generated at the output node Vout via a feed-back path formed by the reference voltage generator 25, the comparator 26, the first PMOS transistor M1, and the resistors R2 and R3. During this normal operating mode, such components dissipate current to consume power.

On the other hand, the standby signal STBYN is set to the logic low level during the standby operating mode. During such a standby operating mode, the reference voltage generator 25 and the comparator 26 are disabled to not operate for conserving power.

Also during such a standby operating mode, the second PMOS transistor M2 is turned on such that the input voltage Vin is applied on the gate of the first PMOS transistor M1 that is then turned off. Additionally during such a standby operating mode, the switch SW1 is turned on to serially connect the resistor R1 with the resistors R2 and R3.

In this manner during the standby operating mode, a second regulated voltage is generated at the output node Vout by voltage division via the resistors R1, R2, and R3 connected in serial between the input voltage Vin and the ground node. The level of such a second regulated voltage is determined by the resistance values of the resistors R1, R2, and R3 and the level of the input voltage Vin.

Thus during the standby operating mode, the feed-back path formed by the reference voltage generator 25, the comparator 26, and the first PMOS transistor M1 is disabled. Rather, a voltage divider path formed by the resistors R1, R2, and R3 is used for generating a regulated voltage at the output node Vout in the standby operating mode.

Advantageously, the components of the feed-back path formed by the reference voltage generator 25, the comparator 26, and the first PMOS transistor M1 are disabled during the standby operating mode for minimizing power consumption in the regulator 20. The power consumption in the regulator 20 during the standby operating mode is determined by the level of current flowing through the resistors R1, R2, and R3.

In an example embodiment of the present invention, the first regulated voltage generated at the output node Vout during the normal operating mode is substantially equal to the second regulated voltage generated at the output node Vout during the standby operating mode. Such voltages may be generated to be substantially equal with appropriate resistance values of the resistors R1, R2, and R3.

In this manner, the voltage regulator 20 generates regulated voltages both in the normal operating mode and in the standby operating mode. In addition, the voltage regulator 20 uses different paths for generating such regulated voltages for minimizing power consumption during the standby operating mode.

While the present invention has been particularly shown and described with reference to exemplary embodiments thereof, it will be understood by those of ordinary skill in the art that various changes in form and details may be made therein without departing from the spirit and scope of the present invention as defined by the following claims. For example, other types of feed-back paths and voltage divider paths may be implemented for generating the regulated voltages during the normal and standby operating modes. In addition, other types of active devices may be used for the PMOS transistors M1 and M2.

What is claimed is:

1. A voltage regulator comprising:
a feed-back path for generating a first regulated voltage using feed-back during a normal operating mode; and
a divider path for generating a second regulated voltage using voltage division during a standby operating mode.

2. The voltage regulator of claim 1, further comprising:
a driver for disabling the feed-back path during the standby operating mode.

3. The voltage regulator of claim 1, wherein the divider path includes:
a voltage divider having a plurality of resistors coupled between a ground node and a terminal for an input voltage during the standby operating mode.

4. The voltage regulator of claim 1, wherein the feed-back path includes:
a voltage divider having a first plurality of resistors for generating the first regulated voltage and a fed-back voltage;
a reference voltage generator for generating a reference voltage;
an active device coupled to the voltage divider; and
a comparator for controlling the active device from comparing the fed-back voltage with the reference voltage,
wherein the active device determines a current level flowing through the first plurality of resistors that generates the first regulated voltage.

5. The voltage regulator of claim 4, wherein the active device is a PMOS (P-channel Metal Oxide Semiconductor) transistor coupled between an input voltage and the first plurality of resistors.

6. The voltage regulator of claim 4, wherein the reference voltage generator, the active device, and the comparator are turned on during the normal operating mode and are turned off during the standby operating mode.

7. The voltage regulator of claim 4, wherein the divider path includes at least one additional resistor coupled in series with the first plurality of resistors between a ground node and a terminal for an input voltage during the standby operating mode.

8. The voltage regulator of claim 7, further comprising:
a switching device coupled between the at least one additional resistor and the first plurality of resistors, wherein the switching device is turned on during the standby operating mode and is turned off during the normal operating mode.

9. The voltage regulator of claim 1, wherein the first regulated voltage and the second regulated voltage are generated at a same output node.

10. The voltage regulator of claim 1, wherein the first regulated voltage and the second regulated voltage are substantially equal.

11. A voltage regulator comprising:
means for generating a first regulated voltage via a feed-back path during a normal operating mode; and
means for generating a second regulated voltage via a voltage divider during a standby operating mode.

12. The voltage regulator of claim 11, comprising:
means for turning off at least one component in the feed-back path during the standby operating mode.

13. The voltage regulator of claim 12, wherein the at least one component in the feed-back path that is turned off during the standby operating mode includes a reference voltage generator and a comparator.

14. The voltage regulator of claim 11, wherein the first regulated voltage and the second regulated voltage are generated at a same output node.

15. The voltage regulator of claim 11, wherein the first regulated voltage and the second regulated voltage are substantially equal.

16. A method for generating regulated voltages comprising:
enabling a feed-back path for generating a first regulated voltage using feed-back during a normal operating mode; and
disabling the feed-back path for generating a second regulated voltage using voltage division during a stand-by operating mode.

17. The method of claim 16, further comprising:
turning off at least one component in the feed-back path during the standby operating mode.

18. The method of claim 17, wherein the at least one component in the feed-back path that is tuned off during the standby operating mode includes a reference voltage generator and a comparator.

19. The method of claim 16, wherein the first regulated voltage and the second regulated voltage are generated at a same output node.

20. The method of claim 16, wherein the first regulated voltage and the second regulated voltage are substantially equal.
